(19) United States
(12) Patent Application Publication
(10) Pub. No.: US 2008/0200425 A1
(43) Pub. Date: Aug. 21, 2008

(54) Methods and compositions for regulating bone mineral density

(76) Inventor: Seymour J. Kurtz, Chicago, IL (US)

Correspondence Address: WINSTON & STRAWN LLP;PATENT DEPARTMENT, 1700 K STREET, N.W., WASHINGTON, DC, 20006, US

(21) Appl. No.: 11/707,135

(22) Filed: Feb. 16, 2007

(51) Int. Cl. C07F 9/38

(52) U.S. Cl. 514/52

(57) ABSTRACT

A method for treating or preventing osteoporosis or a medical condition associated with a reduced or loss of bone mineral density and its related complications, in a mammalian subject is accomplished by intravenously administering to the mammalian subject, a therapeutically effective amount of a sterile aqueous liposomal suspension of lipoprotein small unilamellar vesicles (SUVs) comprising predominantly phospholipids. When the sterile aqueous liposomal suspension is administered to the subject, an increase of bone mineral density is observed over the time of observation.

### FIELD OF THE INVENTION

The present invention relates to a method for treating or preventing osteoporosis or other medical condition associated with a reduction or loss of bone mineral density (BMD) and its related complications in a subject using a therapeutic liposomal suspension, comprising predominantly phospholipids.

### BACKGROUND OF THE INVENTION

The present invention relates to a method for treating or preventing osteoporosis or other medical condition associated with a reduction or loss of bone mineral density (BMD) and its related complications in a subject using a therapeutic liposomal suspension, comprising predominantly phospholipids.

Bone functions to provide mechanical support for joints, tendons and ligaments, protect vital organs from damage and act as a reservoir for both calcium and phosphate in the preservation of normal mineral homeostasis. Any compromise of these functions would lead to clinical problems such as fracture, bone pain, bone deformity and abnormalities of calcium and phosphate homeostasis.

In addition, the bone is a highly dynamic skeletal tissue that undergoes continual turnover (“remodeling” and “renewal”) with old bone being actively resorbed by the bone-resorbing osteoclasts and new bone being deposited by the bone-forming osteoblasts. Bone remodeling occurs throughout life so that any damage in a bone can be replaced by a new one. Remodeling can be divided into four stages: resorption, reversal, formation and quiescence (Raisz, L. G., Ciba Found. Symp., 136:226-238, 1988). At any one time, approximately 10% of the bone surface in the adult skeleton undergoes active remodeling while the remaining 90% is quiescent. Thus, in a growing skeleton, mineralized bone formation exceeds bone resorption whereas in a mature bone, bone loss and bone formation are equivalent, thus, preserving the structural integrity of the bone. Under certain conditions, such as aging, postmenopausal estrogen deficiency, or prolonged steroid treatment, the amount of bone formed is not sufficient to compensate for the quantity lost by resorption. This imbalance, over time, would lead to reduction of bone mass (or bone mineral density (BMD) and compromise of the structural competence of the skeleton.

The bones of the skeleton are not entirely solid throughout. The outside, i.e., cortical, bone is substantially solid throughout, having a few canals. The cortical bone is arranged in so called Haversian systems (canals) which consist of a series of concentric lamella of collagen fibres surrounding a central canal that contains blood vessels. Nutrients reach the central parts of the bone by the interconnecting system of canaliculi that run between the osteocytes (bone cells that lay down new bone and found in the concentric layers of compact bone) buried deep within bone matrix and lining cells of the bone surface. Looking inwardly from the cortical bone is a spongy bone known as cancellous bone, which is composed of a honeycomb network of trabecular bone defining a plurality of spaces or cavities filled with fluid bone marrow, stem cells and some fat cells. Trabecular bone has a greater surface area than cortical bone and based on this, it is remodeled more rapidly. As a result, conditions associated with increased bone turnover tend to affect the trabecular bone more quickly and profoundly than cortical bone.

In an adult, bone mass remains constant only when there is a balance between bone formation and resorption. Over the life of an individual, two or three distinct phases of changes to bone mass occur (Riggs, B. L., West. J. Med., 154(1):63-77, 1991). The initial phase occurs in both men and women and progresses to attainment of peak bone mass. This phase is achieved through linear growth of the endochondral growth plates and radial growth due to rate of periosteal apposition. The second phase begins at around age 30 for trabecular bone (flat bone such as the vertebrae and pelvis) and about age 40 for cortical bone (e.g., long bones of the limbs) and continues to old age. This is distinguished by slow bone loss and occurs in both men and women. In women, a third phase of bone loss also occurs, most likely due to postmenopausal estrogen deficiencies. During this phase alone, women may lose an extra 10% of bone mass from the cortical bone and 25% from the trabecular compartment (see Riggs, B. L., supra).

Loss of bone mineral content or bone mass can be due to a wide variety of conditions, and may result to important medical problems. One example is osteoporosis, a very common debilitating disease in humans characterized by marked decrease in skeletal bone mass and structural bone deterioration including degradation of bone microarchitecture and corresponding increases in bone fragility and susceptibility to fracture in affected individuals. Human osteoporosis is preceded by clinical osteopenia (BMD measurement=>1.0 standard deviation (S.D.) and <2.5 (S.Ds.) below the mean value for young adult bone) and is found in approximately 25 million people in the United States. Risk factors for osteoporosis include smoking, sedentary lifestyle, genetic factors (e.g., Caucasian/Asian, female, and family history), endocrine factors (menopausal age and corticosteroid use), nutritional/lifestyle (e.g., low calcium intake and excessive alcohol intake), low body mass and chronic inflammatory systemic diseases.

In osteoporosis, the most common fractures occur in vertebra, distal radius and hip. Two distinct phases of bone loss have been identified. One is a slow, age-related process that takes place in both genders and begins at about age 35. At this stage, a similar rate in both genders and results in losses of similar amounts of cortical and cancellous (spongy or lattice like) bone. Cortical bone predominates in the appendicular skeleton while cancellous bone is concentrated in the axial skeleton, particularly the vertebrae, as well as in the ends of long bones. Osteoporosis caused by age-related bone loss is known as Type II osteoporosis (seen in men and women typically after the age of. 60). Normal aging is associated with a progressive decline in the supply of osteoblasts and not primarily with the increase in osteoclast activity. Fractures of the femur, femoral neck, proximal tibia, and pelvis are more common in Type II osteoporosis. The other type of bone loss is accelerated, seen in postmenopausal women (and in men after castration) and is caused by estrogen deficiency (testosterone in men). This phase results in a disproportionate loss of cancellous bone. Osteoporosis due to estrogen depletion (or testosterone in men)is known as Type I osteoporosis. The main clinical manifestations of Type I osteoporosis are vertebral, hip and forearm fractures. The skeletal sites of these manifestations contain large amounts of trabecular bone. Bone turnover is usually high in Type I osteoporosis. Bone resorption is increased but there is inadequate compensatory bone formation. Osteoporosis has also been related to corticosteroid use, immobilization or extended bed rest, alcoholism, diabetes, gonadotoxic chemotherapy, hyperprolactinemia, anorexia nervosa, primary and secondary amenorrhea, transplant immunosuppression, and oophorectomy.

Several research groups have disclosed specific methods and compositions to treat osteoporosis or other conditions associated with reduced or loss BMD and their related complications. Below is a brief summary of their disclosures.

Chan et al. reported that statins increased bone mineral density and thereby decreased the risk of osteoporotic fractures. However, these drugs have already been identified as possessing many undesirable side effects which limit their benefits (Chan, M. H. et al., J. Clin. Endocrinol. Metab., 86(9):4556-4559, 2001).

U.S. Pat. No. 6,174,857 discloses pharmaceutical compositions and methods for treating osteoporosis in mammals using insulin growth factor I and a pharmaceutical carrier. The compositions for use in the methods may also include bone anti-resorptive compounds.

U.S. Pat. No. 6,358,925 also discloses a method and pharmaceutical compositions for treating or preventing osteoporosis in higher mammals having or being at substantially risk of developing osteoporosis in cortical bone. The method includes administering insulin growth factor (IGF-1) in an effective amount thereof to the mammal that is in need of such treatment or prevention.

U. S. Patent Application Publication No. 20040151788 teaches a method for increasing bone mineral density that includes the substantially daily consumption of at least one cup of tea for a period of years (preferably with a continuity for at least about of six years). If used as treatment for osteoporosis, the tea consumption is preferably accompanied by treatment with osteoporosis-treating pharmaceutical agents such as anti-resorptives or bone-forming agents.

U.S. Pat. No. 6,022,887 discloses compositions and methods for promoting/stimulating bone growth, as opposed to simply inhibiting resorption or stabilizing bone mass. These compositions and methods utilizes compounds of the claimed inventions that resemble a class of compounds known in the art to behave as antihypercholesterolemic agents, e.g., lovastatin, compactin (mevastatin), simvastatin, and pravastatin. Based on the findings, these compounds are useful in treating osteoporosis, bone fracture or deficiency, primary or secondary hyperparathyroidism, periodontal disease or defect, metastatic bone disease, osteolytic bone disease, post-plastic surgery, post-prosthetic surgery and post-dental implantation.

U. S. Patent Application Publication No. 20040127573 teaches methods of stimulating bone formation by contacting an osteoblast with an osteoblast-stimulatory amount of serotonin reuptake inhibitor (can either be selective or non-selective). The inhibitor binds to a serotonin transport molecule (e.g., 5-hydroxytryptamine transporter; 5-HTT) and such binding reduces the transport of serotonin into the cell.

U.S. Pat. No. 6,495,736 and U. S. Patent Application Publication No. 20040058321 disclose the use of novel class or family of TGF-β-binding proteins to increase bone mineral content for treating variety of conditions such as osteopenia, osteoporosis, fractures or other disorders in which low bone mineral density is the hallmark of the disease.

U. S. Patent Application Publication No. 20050079232 teaches the use of a food composition for preventing, alleviating and/or treating bone disorders and maintenance of bone health in humans and pets, wherein the food composition includes as an active ingredient, an effective amount of at least one plant or plant extract containing phytochemicals having the ability of inducing bone morphogenic protein expression.

U. S. Patent Application Publication No. 20050256047 discloses a method for inducing bone formation and preserving the bone that is produced by minimizing its resorption in a subject that includes the steps of mechanically inducing an increase in osteoblastic activity and elevating blood concentration of at least one anabolic agent in the subject. The bone anabolic agent is a parathyroid hormone that can either be natural, truncate of the natural form, amidated truncate of the natural form or amidated natural form or combinations thereof. Anti-resorption can be achieved by providing the subject with an anti-resorptive agent such as calcitonin.

Both U.S. Pat. No. 6,849,268 and U. S. Patent Application Publication No. 20050256047 disclose methods for increasing bone mineralization in an infant or a juvenile that comprise enterally feeding the infant or juvenile with a formula containing a source of calcium and a source of fat, in which the fatty acid profile is characterized by having a palmitic acid content of about 19 w/w %, or less. This feeding regimen, according to the inventors, will result to an enhancement of the rate of bone mineralization and, ultimately, an enhancement of skeletal strength.

U. S. Patent Application Publication No. 20050026223 discloses a method to increase bone mass without compromising bone strength or quality, through the administration to a host of a compound that binds to the estrogen or androgen receptor without causing hormonal transcriptional activation.

U. S. Patent Application Publication No. 20030175680 discloses the use of 15-lipoxygenase (15-LO) inhibitors for treating and preventing bone loss and/or enhancing bone formation. The inventors of this patent publication discovered the use of 15-LO inhibitors for treatment of osteoporosis and/or osteoarthritis. These 15-LO inhibitor molecules can be delivered alone or in combination with agents that inhibit bone resorption or additional agents that regulate calcium resorption from bone or enhance bone accumulation.

Known drugs that are used in treating osteoporosis and other conditions associated with reduced or low BMD include: parathyroid hormone and modified versions of parathyroid hormone, anabolic steroids, bisphosphonates, calcitonins, androgens, estrogens/progestogens, selective estrogen receptor modulators (SERMs) such as raloxifene, phytoestrogens, parathyroid hormone, fluoride, vitamin D metabolites and calcium preparations.

Although these drug therapies have proven to be effective in treating and preventing osteoporosis and other medical conditions related to reduced or loss of BMD, their applications remain controversial and produce undesirable side effects.

Accordingly, there is a need to provide an improved method of treating the above-mentioned conditions that avoids or minimizes side effects. There is a continuing need to provide a method for treating or preventing a wide variety of conditions including, for example, osteoporosis, osteopenia, fractures and other disorders wherein a low or reduced BMD is a hall mark of the disease.

### SUMMARY OF THE INVENTION

The present invention is based on the discovery that treatment of a subject with intravenously administered liposomes of the type described herein results in an improvement of bone mineral density, with negligible or no side effects.

In one general embodiment, the method is used to regulate bone mineral density or bone health in a subject having a reduced or loss of bone mineral density, as evidenced by the BMD measurements. In a preferred embodiment, the method comprises intravenously administering to a mammalian subject a therapeutically effective amount of a sterile aqueous liposomal suspension of lipoprotein small unilamellar vesicles (SUVs) comprising predominantly phospholipids.

In one aspect, the liposomal suspension of lipoprotein SUVs comprise phospholipids selected from the group consisting of phosphatidylcholine, phosphatidylglycerol and phosphatidylserine. In another aspect, the phosphatidylcholine is 1-palmitoyl, 2-oleoyl phosphatidylcholine and 1-palmitoyl, 2-linoleoyl phosphatidylcholine and can be derived from eggs.

In another embodiment, the lipoprotein SUVs comprise predominantly of phosphatidylcholine having a transition temperature of less than about 37° C., preferably about −10 to 24° C. The liposomal suspension of lipoprotein SUVs further comprises sphingomyelin, cholesterol or other sterols, in an amount less than about 40 mole percent. In yet another embodiment, the lipoprotein SUVs are empty.

In one embodiment, the liposomal suspension is administered one to three times per week to a mammalian subject having the above-described conditions at a dose of about 50 mg-1 g total lipid/kg body weight, preferably at a dose of about 200-450 mg total lipid/kg body weight. The administration can be achieved via intravenous injection or intravenous infusion.

In yet another embodiment, a method is provided for treating or preventing osteoporosis in a human or animal, comprising administering to the subject a therapeutically effective amount of liposomal suspension a sterile aqueous liposomal suspension of lipoprotein small unilamellar vesicles (SUVs) comprising predominantly phospholipids.

The features and details of the invention will become more apparent and appreciated by one skilled in the art to which this invention pertains from the following detailed description of the invention.

### DETAILED DESCRIPTION OF THE INVENTION

In the description that follows, a number of terms are used extensively. The following definitions are provided to facilitate understanding of the invention.

Unless otherwise specified, “a” or “an” means “one or more.”

The terms “bone mass” and “bone mineral density” are synonymous and can be used interchangeably.

As used herein, the term “regulating bone density” will be understood to include the up-regulation, down-regulation or maintenance of bone density. The invention is preferably applicable to the up-regulation of bone density for example, in cases such as osteoporosis, rheumatoid arthritis, hyperthyroidism, hyperparathyroidism, periodontis, and chronic kidney disease.

The term “abnormal bone resorption,” as used herein, means a degree of bone resorption that exceeds the degree of bone formation, either locally or in the skeleton as a whole, or alternatively, can be associated with the formation of bone having abnormal structure.

By “bone mass,” it is meant as the mass of bone mineral and is typically determined by ultrasound (measures the heel and is least accurate), radiographic absorptiometry (RA, uses an X-ray of the hand a small metal wedge to calculate bone density), single energy X-ray absorptiometry (SXA; measures the wrist or heel), peripheral dual energy X-ray absorptiometry (PDXA, measures the wrist, heel or finger), dual energy X-ray absorptiometry (DEXA; measures spine, hip or total body and most widely used), single photon absorptiometry (SPA, measures the wrist), dual energy radioactive photon absorptiometry (DPA; measures spine, hip or total body) and quantitative computerized tomography (QCT; measures spine or hip and most accurate).

The term “bone loss” refers to an imbalance in the ratio of bone formation to bone resorption resulting in less bone than desirable in a subject. Bone loss may result from osteoporosis, osteotomy, periodontis, or prosthetic loosening. It may also result from secondary osteoporosis which includes glucocorticoid-, hyperthyroidism-, immobilization-, heparin-, or immunosuppressive-induced osteoporosis. Bone loss can be monitored, for example, using bone mineral density, as described below.

The term “osteopenia,” as used herein, refers to decreased bone mass below a threshold that compromises the structural integrity of the skeletal bone. An ‘osteopenic’ condition is a condition in which the bone mineral density is decreased compared to a normal control value.

Generally, the lower the BMD, the greater the fracture risk. More specifically, BMD is compared to two norms, “young normal” and “age-matched.” “Young normal” known as the “T-score” compares BMD to optimal or peak density of a 30-year old healthy adult and determines the fracture risk, which increases as BMD falls below young normal levels. “Age-matched,” known as the Z-score, compares BMD to what is expected in someone of the same age, weight, and ethnic or racial origin. A Z-score less than −1.5 indicates that factors other than aging might be causing the bone loss. Among older adults, however, low BMD is common, so comparison with age-matched norms can be misleading. The World Health Organization (WHO) has set the values for interpreting T-scores and defined osteoporosis and osteopenia based on these values (WHO Technical Report Series #843, Geneva, 1994): Normal bone is defined as bone with a T-score above −1. Osteopenia, on the other hand, is defined as a T-score between −1 and −2.5. Osteoporosis is defined as a T-score of below −2.5. Values are based on bone mass at the spine, hip or wrist in white post-menopausal women, who tend to have lower BMD than other racial groups and men. Interpretation may vary with women of color or men.

The terms “effective amount” or therapeutically effective amount “ refer to a nontoxic but sufficient amount of the liposomal suspension to provide the desired biological result. That result can be reduction and/or alleviation of the signs, symptoms, or causes of a disease, or any other desired alteration of a biological system. For example, an “effective amount” for therapeutic uses is the amount of the liposomal suspension herein required to provide a clinically significant increase in healing rates in fracture repair; reversal of bone loss in osteoporosis; prevention or delay of onset of osteoporosis; stimulation and/or augmentation of bone formation in fracture non-unions and distraction osteogenesis; increase and/or acceleration of bone growth into prosthetic devices; and repair of dental defects. An appropriate “effective” amount in any individual case may be determined by one of ordinary skill in the art using routine experimentation.

As used herein, the term “treatment” is to be considered in its broadest context. The term does not necessarily imply that a subject is treated until total recovery. Accordingly, “treatment” includes amelioration of the symptoms or severity of a particular condition or preventing or otherwise reducing the risk of developing a particular condition.

It will be appreciated that by those of general skill in the art to which the invention relates that the present invention is applicable to any bone-containing animal including, but not limited to humans, other mammals, canines, equines (including chickens, turkeys and other meat-producing birds), felines, bovines (including sheep, cows and bulls. Accordingly, the term “subject” includes any animal of interest.

The subject (e.g., human) may be characterized by one or more criteria, for example, sex, age (e.g., 40 years more, 50 years more, 60 years more, etc.), ethnicity, medical history, lifestyle (e.g., smoker, non-smoker), hormonal status (e.g., pre-menopausal, post-menopausal), etc.,

Examples of osteopenic conditions, include arthritis (e.g., rheumatoid arthritis, juvenile arthritis, osteoarthritis, juvenile rheumatoid arthritis, Lime's arthritis, and psoriatic arthritis), osteoporosis, periodontitis, Paget's disease, Cushing's syndrome, and cancers, e.g., myeloma.

Certain cancers, for example, multiple myeloma, lymphoma, leukemia, and gastrointestinal carcinomatosis can result in diffuse loss of bone, especially the trabecular bone of the vertebral column, even in the absence of hypercalcemia.

Osteopenic conditions can be characterized by abnormal levels of PTH, calcium, phosphorus, and vitamin D in the blood or urine. Vitamin D metabolism is regulated by the kidneys. Conditions of renal failure are associated with osteopenia. Loss of kidney function can be correlated with increased blood creatinine.

Osteoporotic fractures mainly affect the spine (vertebral crush fractures), leading to loss of height, kyphosis, and chronic back pain; the distal radius (Colles' fracture); and the most clinically significant, the proximal femur (“hip fractures”).

“Empty” liposomes refers to liposomes that do not contain entrapped or encapsulated drug.

“Small unilammelar vesicles (SUVs)” refer to small single-bilayer liposomes having particle sizes ranging predominantly between 20 and 120 nm. The SUVs of the present invention can be empty. They comprise phospholipids, preferably phospholipids selected from the group consisting of phosphatidylcholine, phosphatidylglycerol, and phosphatidylserine. The phosphatidylcholine may be an egg phosphatidylcholine.

The phrase “milligram or gram total lipid/kg body weight” refers to the amount of total lipids in milligrams or grams comprising the lipoprotein SUVs per kilogram body weight. Total lipids may include phosphatidylcholine, sphingomyelin, cholesterol, phosphatidylserine, phosphatidyglycerol or any other lipids described in the present invention.

A “significant improvement” in a disease state is a measurable degree of improvement, as indicated by either a clinical or biochemical indicator, in the disease state. Typically, a significant improvement in a disease state is one which results in an improvement of a parameter with a known correlation to the disease state of at least five percent.

The terms “elevated blood glucose, insulin, total cholesterol, LDL cholesterol, and triglyceride”, as used herein, refer to concentrations of blood glucose, insulin, total cholesterol, LDL cholesterol, and triglyceride that are on average elevated above the normal average concentrations when measured at various times over the course of a week. A normal range for glucose is generally between 55-115 mg/dl; for triglyceride, 0-200 mg/dl; for total cholesterol, 100-200 mg/dl; and for LDL cholesterol, 0-155 mg/dl.

While not wishing to be bound by a particular theory, the present inventor discovered that a liposomal suspension known to be effective in treating conditions associated with aging, such as heart disease, insulin resistance, adult onset diabetes and metabolic syndrome-X and its related complications, is also effective in increasing bone mineral density in a 77-year old subject. The treatment uses a similar protocol to that which is known in the art. However, this treatment must be adapted to the treatment or prevention of conditions associated with low or loss of bone mineral density and its related complications, as would be apparent to the ordinary skilled physician.

### Pharmaceutical Compositions

The liposomal suspension, as described in detail herein, can be administered in an effective amount to treat any of the conditions described herein.

The sterile aqueous liposomal suspension of the present invention is preferably administered intravenously.

The sterile aqueous liposomal suspension can include minor amounts of the following components: chelating agents such as ethylenediaminetetraacetic acid (EDTA); buffers such as acetates, citrates or phosphates, preservatives and agents for the adjustment of tonicity such as sodium chloride or dextrose. These suspensions can be enclosed in ampoules, disposable syringes or multiple dose vials made of glass or plastic and can be administered intravenously.

The dose and dosage regimen will depend upon the nature of the bone disease, the patient, the patient's history and other factors. The schedule will be continued to optimize effectiveness while balanced against negative effects of treatment. See Remington's Pharmaceutical Science, 17th Ed., 1990, Mark Publishing Co., Easton, Pa.; and Goodman and Gilman's: The Pharmacological Basis of Therapeutics, 8th Ed., 1990, Pergamon Press.

For administration, the active compound will most typically be formulated in a unit dosage injectable form. Examples of injection vehicles include water, saline, Ringer's solution, dextrose solution, and 5% human serum albumin.

It is to be noted that dosage values will also vary with the severity of the condition to be alleviated. Additionally, the liposomal suspension may be administered at once, or may be divided into a number of smaller doses to be administered at varying intervals of time. It is to be further understood that for any particular patient, specific dosage regimens should be adjusted over time according to the individual need and the professional judgment of the person administering or supervising the administration of the compositions, and that the concentration ranges set forth herein are exemplary only and are not intended to limit the scope or practice of the claimed composition.

Administering to a human or animal, the sterile aqueous liposomal suspension according to the present invention results in an improved bone regeneration during fracture healing. It helps to stimulate-bone formation and bone mineral density during growth and optimize peak bone mass. In particular, it may provide an optimal bone growth during childhood. This composition helps to prevent bone loss, in particular bone loss associated with age in mammals or bone loss associated with long term hospitalization. It reduces risk of osteoporosis and improves recovery after fracture. Furthermore, it helps to build cartilage in mammals, prevent bone diseases in humans and animals, which results in a better activity or mobility.

### II. Preparation of Liposomal Composition

The present invention involves intravenous administration of a therapeutic sterile aqueous liposomal suspension to a subject having osteoporosis or a medical condition associated with reduced or loss of BMD and its related complications. The sterile aqueous liposomal suspension comprises lipoprotein small unilammelar vesicles (SUVs), comprising predominantly phospholipids selected from the group consisting of phosphatidylcholine, phosphatidylglycerol, and phosphatidylserine. The phosphatidylcholine may be an egg phosphatidylcholine. Preparation of the lipoprotein SUVs of the present invention is illustrated in the Examples and in the sections which follow.

### A. Preparation of Liposomes: Composition

Lipoproteins are high molecular weight particles that are primarily responsible for lipid transport, namely of triglycerides and cholesterol in the form of cholesteryl esters, through the plasma. Five major classes of naturally-occurring lipoproteins are known to circulate in plasma, each differing in lipid composition, apoprotein composition, density, size, and electrophoretic mobility.

Each lipoprotein particle is composed of a non-polar core region, a surrounding phospholipid surface coating containing small amounts of cholesterol, and exposed at the surface. In vivo, the lipoprotein particles can become associated with apoproteins, e.g., apoproteins A and C, that are responsible for binding to receptors on cell membranes and directing the lipoprotein carrier to its intended site of metabolism.

In one preferred embodiment, described and used in the examples below, the lipoprotein SUVs comprise predominantly (more than 50 mole percent, preferably more than 80-90 mole percent) of phosphatidylcholine (PC) having a phase transition temperature less than about 37° C., preferably about −10 to 24° C., e.g., below about 5° C.

PC phospholipids include those phospholipids having a choline moiety and where the fatty acid chain portion of the phospholipid may vary in length and degree of unsaturation. In addition, PC phospholipids also include synthetic PCs that are not crystalline at body temperature (e.g., those containing at least one double bond) yet are resistant to oxidation (e.g., those that do not have double bands, such as 1-palmitoyl, 2-oleoyl PC (POPC)). PC phospholipids may further include natural or synthetic phospholipids, alone or in mixtures having supplemented or replaced hydrophobic or amphipathic material that still maintains a liposomal or micellar structure.

One preferred vesicle composition includes egg PC, which has a transition temperature of −5° C. that contains predominantly 1-palmitoyl, 2-oleoyl PC and 1-palmitoyl, 2-linoleoyl PC. Alternatively, phosphatidylcholine may be isolated from rat liver (Newman, H. A. I. et al., J. Lipid Res., 2:403-11, 1961), followed by purification on alumina (Shinitzky, M. et al., J. Biol. Chem., 249:2652, 1974).

The lipoprotein SUVs may be composed entirely of egg PC, or may contain other lipid components which (i) are not immunogenic, (ii) do not contribute a significant portion, i.e., more than 25-50 mole percent, of lipids with high phase transition temperature. Additional components may include negatively charged lipids, such as phosphatidylglycerol (PG) or phosphatidylserine (PS). Addition of PG would make the SUVs negatively charged or charge other components of the lipoprotein SUVs to prevent aggregation during storage. If the lipoprotein SUVs is composed entirely of PC, the mole percentage of PG and PS is less than 1% with respect to PC. However, if PC is not a major component of the lipoprotein SUVs, the mole percentage of PG and PS would be more than 1% but not more than 50% with respect to PC. The lipoprotein SUVs may also encompass sphingomyelin (SM), cholesterol or other sterols, in an amount preferably less than about 40 mole percent. Other components may also include diacylglycerol, phosphatidylinositol, oxidized lipids, lysophosphatidylcholine, and proteins, such as phospholipid transfer proteins (PLTP; see Biomembranes Structural and Functional Aspects, M. Shinitzky (ed.), 1994, at page 40) and amniophospholipid translocase (either as a 116-kd Mg²⁺ ATPase (Morot, G. et al., Biochemistry, 28: 3456, 1989; Morot, G. et al., FEBS Lett. 266: 29, 1990) or as a 32-kd protein (Schroit, A. J. et al., Biochim. Biophys. Acta, 1071: 313, 1991)).

Lipid protective agents, such as α-tocopherol, α-tocopherol acetate, or α-tocopherol succinate, may also be included in the lipids forming the lipoprotein SUVs, to protect the lipid components against free radical damage. Typically such agents are included at a mole percentage between about 0.5% and 2%. It may be advantageous to add α-tocopherol to the lipoprotein SUVs to maintain a balance between vitamin E and polyunsaturated lipids in the lipoprotein SUVs. Alternatively, the lipoprotein SUVs can be prepared and stored in an inert gas atmosphere, e.g., nitrogen, argon and the like.

### B. Preparation of Unsized Liposomes

A variety of methods for producing lipoprotein SUVs are available, and these have been extensively reviewed (Szoka, F. et al., Ann. Rev. Biophys. Bioeng., 9:467, 1980). In general, these methods produce lipoprotein SUVs with heterogeneous sizes from about 0.02 to 10 microns or greater. As will be discussed below, lipoprotein SUVs which are relatively small and well-defined in size are preferred for use in the present invention, hence a second processing step for reducing the size and size heterogeneity of liposomal suspensions will usually be required.

In one preferred method for forming the initial liposome suspension as described in Example 1, the vesicle-forming lipids are taken up in a suitable organic solvent system, preferably in a siliconized glass vessel, and dried in vacuo or under an inert gas to form a lipid film. An aqueous suspension medium, such as a sterile saline solution, is added to the film, and the vessel is agitated (e.g., on a shaker or using a sonicator) until the lipids have hydrated to completion, typically within about 1-2 hours. The amount of aqueous medium added is sufficient to produce a final liposome suspension containing preferably between about 5 and 30 g total lipid per 100 ml media, preferably 10 g total lipid per 100 ml media.

During the hydration stage, the lipids hydrate to form multi-lamellar vesicles (MLVs) with sizes ranging between about 0.5 microns to about 10 microns or larger. In general, the size distribution of MLVs can be shifted toward slightly smaller sizes by hydrating the lipids under more vigorous agitation conditions.

The aqueous medium used in forming the lipoprotein SUVs may contain water-soluble agent(s) which enhance the stability of the liposomes upon storage. A preferred stabilizing agent is an iron-specific trihydroxamine chelating agent, such as desferrioxamine. The use of this compound in reducing lipid peroxidation and free radical damage in drug-containing liposomes has been reported in U.S. Pat. No. 4,797,285. Briefly, it was shown that the combination of a lipophilic free-radical quencher, such as α-tocopherol, and the water-soluble chelator gave substantially better protection against lipid peroxidation damage than did either of the protective agents alone. The chelator is included in the aqueous medium in molar excess of the amount of free iron in the medium. Typically, a chelator concentration of between about 10-200 micromolar is sufficient for reducing lipid peroxidation and free radical damage.

### C. Sizing Liposomes: SUV Preparation

The suspension of lipoprotein SUVs prepared as described above is preferably further treated to produce liposomes having a desired size and size homogeneity.

The liposome suspension is generally sized to achieve a selective size distribution of vesicles in a size range less than about 1.2 micron and preferably less than about 0.8 microns. Liposomes in this size range can be readily sterilized by filtration through a depth filter. Smaller vesicles also show less tendency to aggregate on storage, thus reducing the potential for serious vascular blockage problems upon intravenous administration of the final liposomal composition of the present invention. Finally, lipoprotein SUVs which have been sized down to the submicron range possess more uniform biodistribution and drug clearance characteristics.

Preferred lipoprotein SUVs, i.e., single-bilayer liposomes, have sizes between about 0.02 to 0.12 microns. SUVs have been shown to possess relatively long blood circulation half lives, when administered intravenously, as described in U.S. Pat. No. 6,235,308, filed Jun. 10, 1994. Briefly, as described therein, plots of liposome retention in the bloodstream, measured up to 1,000 minutes after IV injection, revealed that significant quantities of liposomes remained in the bloodstream even at 1,000 minutes.

Several techniques are available for reducing the sizes and size heterogeneity of liposomes, in a manner suitable for preparing the lipoprotein SUVs of the present invention. Ultrasonic irradiation of a liposome suspension either by bath or probe sonication produces a progressive size reduction down to SUVs.

Homogenization is another method which relies on shearing energy to fragment large liposomes into smaller ones. In a typical homogenization procedure, MLVs are recirculated through a standard emulsion homogenizer until selected liposome sizes, typically less than 0.1 microns, are observed.

Extrusion of liposomes through a small-pore polycarbonate membrane is an effective method of reducing liposome size down to a relatively well-defined size distribution. An average range is between about 0.03 and 1 micron, depending on the pore size of the membrane, such as described in Example 2. Typically, the suspension is cycled through the membrane several times until the desired liposome size distribution is achieved. The lipoprotein SUVs may be extruded through successively smaller pore membranes, to achieve a gradual reduction in liposome size.

Liposome particle sizes can be determined by a number of techniques including electron microscopy, comparative chromatography (Bisgaier, C. L. et al., J. Biol. Chem. 264(2):862-866, 1989) and quasi-elastic light scattering.

The size-processed liposome suspension may be readily sterilized by passage through a sterilizing membrane having a particle discrimination size of about 0.2 μ, such as a conventional 0.22 μ depth membrane filter. If desired, the liposome suspension can be lyophilized for storage and reconstituted shortly before use.

### III. Methods for Regulating Bone Mineral Density

This section describes a treatment method which involve intravenous administration of the sterile aqueous liposomal suspension described above. In this method, the suspension is administered intravenously at a dose and dosing frequency effective to produce a desired improvement in the treated condition.

A preferred dosing frequency is one, two or three times per week. The dosing periods, e.g., two weeks, may be interrupted by a wash-out period, typically of 1-4 weeks. The treatment, e.g., involving repeating dosing and wash-out periods, may continue over an extended period of several months or more.

In a preferred embodiment, the liposome suspension is administered one to three times per week, at a dose of about 50 mg-1 g total lipid/kg body weight per dose, preferably between about 200-450 mg total lipid/kg body weight per dose. Administration may be by i.v. (intravenous) injection, or i.v. drip (infusion). The lipoprotein SUVs may be suspended in sterile saline or in a nutritional or drug-containing buffer or medium, such as a glucose/salt medium, to combine liposome treatment with other therapy.

Administration of the sterile aqueous liposomal suspension is continued until a significant and measurable improvement of the disease is observed and wherein the bone mineral density falls back within the normal range or is significantly increased.

A liposomal suspension is said to be administered in a “therapeutically effective amount” if the amount administered is physiologically significant. It is physiologically significant if its presence results in a detectable change in the physiology of a recipient subject. In particular, an amount of a sterile aqueous liposomal suspension administered according to the present invention is physiologically significant if it results in an increased in bone mineral density.

### EXAMPLES

The following examples illustrate various methods for preparing sterile aqueous liposome compositions and using the compositions in the treatment method of the invention. The examples are intended to illustrate, but in no way limit, the scope of the invention.

### Materials

Egg phosphatidylcholine (egg PC) may be purchased from Avanti Polar Lipids (Alabaster, Ala.) or Lipoid KG (Ludwigshafen, Germany). The egg PC was determined to be greater than 99% pure. The egg PC fatty acid composition was similar to the reported composition (Hertz, R. et al., Chem. Phys. Lipid, 15:138, 1975). The main PCs of the preparation included 1-palmitoyl, 2-oleoyl PC and 1-palmitoyl, 2-linoleoyl PC.

### Example 1

### Preparation of Small Unilamellar Vesicles by Sonication

Egg PC dissolved in chloroform was placed in a 100 ml vessel and dried to a thin film under an inert atmosphere of nitrogen. Sterile saline was added to the lipid film to a final concentration of about 100 mg/ml, and the lipid film was hydrated with swirling. The resulting multi-lamellar vesicle (MLV) suspension was then bath sonicated for 1 hour using a Heat System Sonicator, Model 375W, at a power setting of 40-50% full value. The temperature of the suspension was maintained at about 4° C. during sonication. Large vesicles or MLVs were separated from the sonicated suspension by ultracentrifugation at 100,000 g for 1 hour (Barenholz, Y. et al., Biochemistry, 16:2806, 1977). The remaining suspension of SUVs, having a concentration of about 100 mg/ml, was then filter sterilized.

### Example 2

### Preparation of Small Unilamellar Vesicles by Extrusion

Homogeneous small unilamellar vesicles (SUVs) of egg PC for human use with an average diameter of 65 nm±10 nm in size, in 0.15M NaCl, were prepared by extrusion using serial filtration through polycarbonate filters in a GH 76-400 pressure cell (Nucleopore) (Anselem, S., et al., In Gregoriadis, G. (ed), LIPOSOME TECHNOLOGY, pp. 501-524, CRC Press, Boca Raton, Fla., 1993). These vesicles were empty SUVs.

Liposomal particle size was measured by Nicomp submicron laser particle sizer, by Quasielectric light scattering or comparable method. It can also be determined using a Coulter model N4 sub-micron particle analyzer equipped with a size distribution processor analyzer (Barenholz et al. In Gregoriadis, G. (ed), LIPOSOME TECHNOLOGY, pp. 524-607, CRC Press, Boca Raton, Fla., 1993). The final extrusion step was through a 0.05 micrometer pore polycarbonate filter. Egg PC SUV's should be sterile and pyrogen-free and were sterilized by filtration through sterile 0.22 micrometer Millipore filters. They were packaged in 100 ml transparent moulded hydrolytic class I bottles, evacuated with nitrogen (N) with teflon coated standard stoppers (20 mm), and sealed with an Alu-cap with PE-disc.

The final product had a more than 99% purity. Total impurity values were NMT 1%, as measured by HPLC, GC/FID or comparable procedure. There was no single impurity greater than 0.3%. Total oxidation values were NMT 1%, as measured by UVNIS spectrometry at 234, 268 and 278 nm.

Below is some additional information relating to the final SUV liposomal product:

Lipid concentration: 5-20%, preferably 10%.

Chemical stability: Hydrolysis and peroxidation <1%.

Sterility: Passes FDA mandated standards for sterile solution. NMT 100 CFU per test sample. Conforms to USP standards.

Storage Conditions:

| Room Temperature | Refrigerated Temperature | Accelerated Temperature |
|---|---|---|
| (25° C., 60% RH) | (4° C., 45% RH) | (40° C., 75% RH) |
| 1 week | 1 week | 1 week |
| | | 2 weeks |
| 1 month | 1 month | 1 month |
| 2 months | 2 months | 2 months |
| 3 months | 3 months | 3 months |
| 6 months | 6 months | 6 months |

Dose regimen: 50 mg-1 g total lipid/kg body weight.

Dosage form: White-yellowish translucent dispersion for intravenous infusion.

Contraindication: Allergy to eggs; having hemolytic red blood cells.

Adverse effects: No adverse effects found.

Liposomal Concentration: 100 mg/ml

Fatty acid composition of the egg PC (by weight):

| | |
|---|---|
| Palmitic acid | 35.6% |
| Stearic acid | 12.6% |
| Oleic Acid | 27.8% |
| Linoleic Acid | 17.9% |
| Arachidonic Acid | 9.5% |
| Docosapentaenoic acid | 0.7% |
| Docosahexaenoic acid | 2.0% |

Complete Liposomal Suspension:

| | | |
|---|---|---|
| 10 | g | phospholipids of which: |
| 9.9 | g | egg PC, |
| 0.2–0.50 | g | cholesterol and |
| 0.05–2.0 | g | sphingomyelin |
| 0.012 | g | Desferal ® |
| 0.9 | g | sodium cholride |

Sterile pyrogen-free water for injection to 100 ml.

### Example 3

### Alternative Preparation of Small Unilamellar Vesicles by Extrusion

Homogeneous small unilamellar vesicles (SUVs) of egg PC for human use with an average diameter of 60 nm+5 nm in size, were prepared by extrusion using filtration through polycarbonate membrane filters using an Aviston EmulsiFlex-C50 homogenizer with SuporCap™ and SuporDCF™ serial layer disposable filters (220 nm, 180 nm and 80 nm). These vesicles were empty SUVs.

Liposomal particle size was measured by Solvias AG, Basel, Switzerland submicron laser particle sizer, by Quasielectric light scattering or comparable method. It can also be determined using a Coulter model N4 sub-micron particle analyzer equipped with a size distribution processor analyzer (Barenholz et al., In Gregoriadis, G. (ed), LIPOSOME TECHNOLOGY, pp. 524-607, CRC Press, Boca Raton, Fla., 1993). The final extrusion step was through a 0.08 μm pore polycarbonate membrane filter. Egg PC SUV's should be sterile, endotoxin (LAL)-free and pyrogen-free and were sterilized by filtration through sterile 0.22 μm pore polycarbonate membrane filters. They were packaged in 100 ml transparent moulded hydrolytic class II bottles, evacuated with nitrogen (N) with teflon coated standard stoppers (20 mm), and sealed with an Alu-cap with PE-disc.

The final product had a more than 99% purity. Total impurity values were NMT 1%, as measured by HPLC, GC/FID or comparable procedure. There was no single impurity greater than 0.3%. Total oxidation values were NMT 1%, as measured by UVNIS spectrometry at 215, 233, and 279 nm.

Below are some additional information relating to the final SUv liposomal product:

Lipid concentration: 5-30%.

Chemical stability: Hydrolysis and peroxidation <1%.

Dosage form: White-yellowish translucent dispersion for intravenous infusion.

Sterility: Passes FDA mandated standards for sterile solution. NMT 100 CFU per test sample. Conforms to USP standards.

Storage Conditions:

Refrigerated Temperature
(4° C., 45% RH)

1 month
2 months
3 months
5 months
6 months
7 months

Dose regimen: 50 mg-1 g total lipid/kg body weight.

Contraindication: allergy to eggs; having hemolytic red blood cells.

Adverse effects: No adverse effects found.

Fatty acid composition of the egg PC (by weight):

| | |
|---|---|
| Palmitic acid | 35.6% |
| Stearic acid | 12.6% |
| Oleic Acid | 27.8% |
| Linoleic Acid | 17.9% |
| Arachidonic Acid | 9.5% |
| Docosapentaenoic acid | 0.7% |
| Docosahexaenoic acid | 2.0% |

Complete Liposomal Suspension:

| | | |
|---|---|---|
| 10 | g | phospholipids of which |
| 9.0 | g | Egg PC (Lipoid) |
| 0.2–0.5 | g | cholesterol and |
| 0.05–2.0 | g | sphingomyelin |
| 0.018 | g | DESFERAL ® |
| 0.765 | g | sodium chloride (Merck) |
| 0.279 | g | L-histidine (Fluka) |

Adjust pH to 6.5 with 1 M sodium hydroxide or 1 M hydrochloric acid

| | | |
|---|---|---|
| 99.9945 | g | Sterile pyrogen-free |
| | | water (final |
| | | volume: 100 ml), |
| | | and nitrogen q.s. |

### Example 4

### Effects of Liposomal Treatment on Bone Mineral Density

Patient 1 is a seventy-seven year old man was seen by an outpatient doctor at Max Grundig Klinik, Buhl, Germany on Apr. 29, 2002 and Jun. 17, 2005. During that period, Patient 1 did not receive any medication (anti-osteoporotic or hormone medication). However, Patient 1 did receive the claimed liposomal composition on May 17, 2002, under the supervision of the attending physician.

Routine serological tests were conducted on Patient 1 and the results were within normal limits. A bone mineral density scan using the DEXA method (Hologic Technique) was also performed. Surprising results obtained from DEXA scanning revealed that Patient No. 1 showed an increase bone mineral density over the time of observation (Jun. 29, 2002-Jun. 17, 2005) instead of a prognostic age-dependent BMD loss of about 3% per year. DEXA scanning results are as follows:

| | Before | After |
|---|---|---|
| BMD (DEXA, Hologic) | (Jun. 29, 2002) | (Jun. 17, 2005) |
| Left neck of the hip T-score | −2.66 | −2.28 |
| Lumber spine (L1–4) | −1.75 | −0.18 |

The above documented data was contrary to the expected biological decrease of BMD in age dependency. In fact, the BMD data revealed an improvement of bone density. This is unexpected in the field of osteoporosis treatment since no anti-osteoporotic therapy was applied during the time of observation and before and after treatment of the claimed liposomal composition.

Patient 1 tolerated the liposomal therapy very well. He showed no signs or symptoms of any unwanted side effects. No subjective or clinical adverse symptoms was observed. His laboratory results remained within the normal limits.

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other documents.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

What is claimed is:

1. A method for regulating bone mineral density or bone health in a subject, comprising administering to said subject a therapeutically effective amount of sterile aqueous liposomal suspension of lipoprotein small unilamellar vesicles (SUVs) comprising predominantly phospholipids.

2. The method of claim 1, wherein said phospholipids are selected from the group consisting of phosphatidylcholine, phosphatidylglycerol and phosphatidylserine.

3. The method of claim 2, wherein said phosphatidylcholine is egg phosphatidylcholine.

4. The method of claim 2, wherein said phosphatidylcholine is 1-palmitoyl, 2-oleoyl phosphatidylcholine, 1-palmitoyl, 2-linoleoyl phosphatidylcholine or a mixture thereof.

5. The method of claim 2, wherein said phosphatidylcholine has a transition temperature of less than about 37° C.

6. The method of claim 5, wherein said transition temperature is in the range of about −10 to 24° C.

7. The method of claim 1, wherein said lipoprotein SUVs further comprise one or more compounds selected from the group consisting of sphingomyelin, cholesterol and other sterols, in a total amount less than about 40 mole percent.

8. The method of claim 1, wherein said lipoprotein SUVs are empty and are in the size range of 20-120 nm.

9. The method of claim 1, wherein said liposomal suspension is administered one to three times per week to said mammalian subject at a dose for each administration of about 50 mg-1 g total lipid/kg body weight.

10. The method of claim 9, wherein said dose is about 200-450 mg total lipid/kg body weight.

11. The method of claim 1, wherein said liposomal suspension is administered by intravenous injection or intravenous infusion.

12. A sterile aqueous liposomal suspension of lipoprotein small unilamellar vesicles (SUVs) comprising predominantly phospholipids for use in the preparation of a medicament for regulating bone mineral density or bone health in a subject exhibiting a reduction of bone mineral density or poor bone health.

13. The liposomal suspension of claim 12, wherein said phospholipids are selected from the group consisting of phosphatidylcholine, phosphatidylglycerol and phosphatidylserine.

14. The liposomal suspension of claim 13, wherein the size of said lipoprotein SUVs is in the range of 20-120 nm.

15. The liposomal suspension of claim 13, wherein said phosphatidylcholine is 1-pahnitoyl, 2-oleoyl phosphatidylcholine, 1-palmitoyl, 2-linoleoyl phosphatidylcholine or a mixture thereof.

16. The liposomal suspension of claim 13, wherein said phosphatidylcholine has a transition temperature of less than about 37° C.

17. The liposomal suspension of claim 16, wherein said transition temperature is in the range of about −10 to 24° C.

18. The liposomal suspension of any one of claims 12, wherein said lipoprotein SUVs further comprise sphingomyelin, cholesterol or other sterols, in an amount less than about 40 mole percent.

19. A method for treating or preventing osteoporosis in a subject, comprising administering to said subject a therapeutically effective amount of liposomal suspension of sterile aqueous lipoprotein small unilamellar vesicles (SUVs) comprising predominantly phospholipids.

20. A method of promoting improved healing of bone fractures in a subject, comprising administering to said subject suffering from a fractured bone a therapeutically effective amount of sterile aqueous liposomal suspension of lipoprotein small unilamellar vesicles (SUVs) comprising predominantly phospholipids.
